(19) United States
(12) Patent Application Publication
(10) Pub. No.: US 2024/0309268 A1
(43) Pub. Date: Sep. 19, 2024

(54) COMPOSITION, AND RESIN MOLDED BODY AND METHOD FOR PRODUCING SAME

(71) Applicants: Ayumi Nihei, Yokohama-shi (JP); HAMAMATSU PHOTONICS K.K., Hamamatsu-shi (JP)

(72) Inventors: Takahiko Yamanaka, Hamamatsu-shi (JP); Shigeo Hara, Hamamatsu-shi (JP); Yoshitaka Kurosaka, Hamamatsu-shi (JP); Ayumi Nihei, Yokohama-shi (JP)

(73) Assignee: HAMAMATSU PHOTONICS K.K., Hamamatsu-shi (JP)

(21) Appl. No.: 18/603,403

(22) Filed: Mar. 13, 2024

(30) Foreign Application Priority Data
Mar. 15, 2023 (JP) 2023-040648

(51) Int. Cl. C09K 11/02; C08F 220/28; C08F 222/20; C08K 9/04; C09K 11/77

(52) U.S. Cl. CPC C09K 11/025; C08F 220/281; C08F 222/20; C08K 9/04; C09K 11/7773; C08F 2800/20; C08K 2201/005; C08K 2201/011

(57) ABSTRACT

Provided is a resin molded body with an improved luminous efficiency. Also provided is a composition for obtaining the resin molded body, and a method for producing a resin molded body.

A composition including: particles containing an upconversion material that receives excitation light in a first wavelength range and emits light in a second wavelength range shorter than the first wavelength range; and a curable component, in which the upconversion material contains a rare earth element, and the curable component includes a compound having an alkylene glycol group.

### TECHNICAL FIELD

The present invention relates to a composition, and a resin molded body and a method for producing the same.

### BACKGROUND

Non-Patent Document 1 discloses a transparent composite material (resin molded body) obtained by polymerizing a composition containing upconversion nanoparticles, polyethylene glycol monooleate (surfactant), and a methyl methacrylate monomer. Patent Document 1 discloses a composition containing upconversion nanoparticles and a surfactant such as polyethylene glycol.

### Patent Documents

[Patent Document 1] PCT International Publication No. WO2012/019081

[Non-Patent Document 1] J. C. Boyer, et al., “Upconverting Lanthanide-Doped NaYF4-PMMA Polymer Composites Prepared by in Situ Polymerization,” Chem. Mater. 2009, 21, 2010-2012.

### SUMMARY

In a composition containing upconversion nanoparticles, a surfactant is used to disperse upconversion nanoparticles, but since the surfactant is localized around the upconversion nanoparticles, the luminous efficiency of a resulting resin molded body is less likely to increase.

An object of the present invention is to provide a resin molded body with an improved luminous efficiency. In addition, another object of the present invention is to provide a composition for obtaining the resin molded body, and a method for producing a resin molded body.

The present invention includes, for example, inventions of [1] to [13] below.
[1] A composition including: particles containing an upconversion material that receives excitation light in a first wavelength range and emits light in a second wavelength range shorter than the first wavelength range; and a curable component, in which the upconversion material contains a rare earth element, and the curable component includes a compound having an alkylene glycol group.
[2] The composition according to [1], in which the upconversion material contains at least one selected from the group consisting of yttrium, ytterbium, and erbium.
[3] The composition according to [1] or [2], in which the upconversion material contains a fluoride of the rare earth elements.
[4] The composition according to any one of [1] to [3], in which an average value of maximum lengths of the particles is 100 nm to 10 μm.
[5] The composition according to any one of [1] to [4], in which an average particle diameter of the particles is 100 nm to 10 μm.
[6] The composition according to any one of [1] to [5], in which the particles are coated with an unsaturated fatty acid.
[7] The composition according to any one of [1] to [6], in which a content of the particles is 0.1 mass % to 20 mass % based on a total amount of the composition.
[8] The composition according to any one of [1] to [7], in which the compound having the alkylene glycol group is an ultraviolet curable compound.
[9] The composition according to any one of [1] to [8], in which the compound having the alkylene glycol group has an ethylene glycol group.
[10] The composition according to any one of [1] to [8], in which the curable component includes a first curable component and a second curable component having a greater number of functional groups than the first curable component.
[11] A resin molded body including: a cured product of the composition according to any one of [1] to [10].
[12] A method for producing a resin molded body, including: a step of preparing a composition containing particles containing an upconversion material that receives excitation light in a first wavelength range and emits light in a second wavelength range shorter than the first wavelength range, and a curable component; and a step of curing the composition, in which the upconversion material contains a rare earth element, and the curable component includes a compound having an alkylene glycol group.
[13] The method according to [12], further including: a step of molding the composition between the step of preparing the composition and the step of curing the composition.
[14] The composition according to [12] or [13], in which the compound having the alkylene glycol group is an ultraviolet curable compound, and in the curing step, the composition is cured by irradiating the composition with ultraviolet light.

According to the present invention, it is possible to provide a resin molded body with an improved luminous efficiency. In addition, according to the present invention, it is possible to provide a composition for obtaining the resin molded body, and a method for producing a resin molded body.

### DETAILED DESCRIPTION

Hereinafter, an embodiment of the present invention will be described in detail. However, the present invention is not limited to the following embodiment.

### Composition

A composition according to one embodiment of the present invention includes particles containing an upconversion material that receives excitation light in a first wavelength range and emits light in a second wavelength range shorter than the first wavelength range, and a curable component. The upconversion material contains a rare earth element, and the curable component contains a compound having an alkylene glycol group. By curing the composition according to the present embodiment, it is possible to obtain a resin molded body and to improve the luminous efficiency of the resulting resin molded body.

### Particles Containing Upconversion Material

A composition according to the present embodiment includes particles containing an upconversion material that receives excitation light in a first wavelength range and emits light in a second wavelength range shorter than the first wavelength range (hereinafter, these particles are also referred to as “UC particles”). The upconversion material means a material having an action of converting long-wavelength, low-energy light such as near-infrared light into high-energy light with a shorter wavelength.

The upconversion material contains a rare earth element. The rare earth element may be a trivalent rare earth element. Examples of such rare earth elements include yttrium, ytterbium, erbium, lanthanum, gadolinium, neodymium, thulium, and holmium. The upconversion material may contain at least one selected from the group consisting of yttrium, ytterbium, and erbium from the viewpoint of further improving the luminous efficiency.

The upconversion material may contain a plurality of rare earth elements. For example, the upconversion material may contain, from the viewpoint of more easily improving the luminous efficiency, a rare earth element as an emission species (such as erbium, thulium, and holmium), a host rare earth element (such as ytterbium, lanthanum, and gadolinium), and a rare earth element as an energy donor (such as ytterbium and neodymium).

The upconversion material may contain oxides of rare earth elements or may contain fluorides of rare earth elements. The upconversion material may contain, from the viewpoint of more easily improving the luminous efficiency, fluorides of rare earth elements, for example, MLnF₄ (M: a metal atom of such as sodium, Ln: a rare earth element).

Examples of crystal systems of UC particles include a cubic crystal system, a hexagonal crystal system, a triclinic crystal system, a monoclinic crystal system, an orthogonal crystal system, and a tetragonal crystal system. For example, in a case where UC particles have a structure of MLnF₄, the UC particles have a cubic or hexagonal crystal system.

The average value of maximum lengths of UC particles may be 50 nm or more, 80 nm or more, or 100 nm or more from the viewpoint of more easily improving the luminous efficiency. The average value of maximum lengths of UC particles may be 200 nm or more, 300 nm or more, 400 nm or more, or 500 nm or more. The average value of maximum lengths of UC particles may be 10 μm or less, 8 μm or less, 6 μm or less, 4 μm or less, 2 μm or less, or 1 μm or less from the viewpoint of improving dispersibility of UC particles in the composition. The average value of maximum lengths of UC particles may be 800 nm or less, 600 nm or less, 500 nm or less, 400 nm or less, 300 nm or less, 200 nm or less, or 100 nm or less. The average value of maximum lengths of UC particles is measured by dispersing UC particles in a hexane solvent at a mass ratio of 99:1 (hexane solvent:UC particles), forming a film on a conductive substrate through a spin coating method to obtain a measurement sample, followed by observing the measurement sample at a magnification of 80,000 times using a scanning electron microscope (SEM), measuring the maximum lengths of each particle under the conditions where 10 UC particles are visible within the same angle of view, and averaging the maximum lengths of the 10 UC particles.

The average particle diameter UC particles may be 40 nm or more, 70 nm or more, 90 nm or more, or 100 nm or more from the viewpoint of more easily improving the luminous efficiency. The average particle diameter of UC particles may be 200 nm or more, 300 nm or more, or 400 nm or more. The average particle diameter of UC particles may be 10 μm or less, 8 μm or less, 6 μm or less, 4 μm or less, 2 μm or less, 1.5 μm or less, or 1 μm or less from the viewpoint of improving dispersibility of UC particles. The average particle diameter of UC particles may be 800 nm or less, 600 nm or less, 500 nm or less, 400 nm or less, 300 nm or less, 200 nm or less, or 150 nm or less. The average particle diameter of UC particles is measured by dispersing UC particles in a hexane solvent at a mass ratio of 99:1 (hexane solvent:UC particles) to obtain a sample solution, followed by subjecting the sample solution to dynamic scattering measurement (measurement device: Litesizer 500 manufactured by Anton Paar GmbH).

UC particles may be coated with unsaturated fatty acids from the viewpoint of improving dispersibility of UC particles in the composition. Example of unsaturated fatty acids include palmitoleic acid, sapienic acid, oleic acid, elaidic acid, vaccenic acid, gadoleic acid, and eicosenoic acid.

The degree of coverage of unsaturated fatty acids on UC particles can be confirmed through infrared (IR) spectroscopy measurement. Specifically, the degree of coverage thereof can be confirmed by calculating the ratio of an IR peak intensity originating from alkyl chains to an IR peak intensity originating from rare earth elements (IR peak intensity originating from alkyl chains/IR peak intensity originating from rare earth elements).

The greater the degree of coverage of unsaturated fatty acids on UC particles (that is, the greater the above-described ratio), the more the dispersibility of the UC particles tends to improve. The lower the coverage of unsaturated fatty acids on UC particles (that is, the lower the above-described ratio), the better the luminous efficiency tends to be. The above-described ratio may be 0.01 or more, 0.05 or more, or 0.1 or more from the viewpoint of improving dispersibility of UC particles in the composition. The above-described ratio may be 100 or less, 50 or less, or 10 or less from the viewpoint of more easily improving luminous efficiency.

The content of UC particles based on the total amount of the composition may be 0.1 mass % or more, 0.5 mass % or more, 1 mass % or more, 1.5 mass % or more, 2 mass % or more, or 2.5 mass % or more from the viewpoint of more easily improving luminous efficiency. The content of UC particles based on the total amount of the composition may be, 20 mass % or less, 15 mass % or less, 10 mass % or less, 8 mass % or less, 5 mass % or less, 4 mass % or less, 3.5 mass % or less, or 3 mass % or less from the viewpoint of suppressing light scattering.

### Curable Component

The composition according to the present embodiment contains, as a curable component, a compound having an alkylene glycol group. The alkylene glycol group means a divalent structure represented by —(CₙH₂ₙO)ₘ—(n and m are each an integer of 1 or more).

Examples of curable components include a UV-curable compound and a thermosetting compound. When curing the composition to obtain a molded body, a curable component may be a UV-curable compound from the viewpoint of suppressing aggregation of UC particles to easily obtain a resin molded body in which the UC particles are uniformly dispersed.

Examples of UV-curable compounds include a (meth)acrylic monomer, a (meth)acrylic resin, an epoxy monomer, an epoxy resin, a silicone resin, a urethane resin, and an amide resin. A curable component may contain at least one selected from the group consisting of a (meth)acrylic monomer, an epoxy monomer, and a vinyl monomer, or may contain a (meth)acrylic monomer. A (meth)acrylic monomer may be monofunctional or polyfunctional (bi-or higher functional). In the present specification, “(meth)acrylic monomer” means at least one of “acrylic monomer” and “methacrylic monomer” corresponding thereto, and the same applies to other similar expressions such as a (meth)acrylic resin.

Examples of monofunctional (meth)acrylic monomers include 2-ethylhexyl glycol (meth)acrylate, methoxypolyethylene glycol (meth)acrylate, ethoxypolyethylene glycol (meth)acrylate, methoxy polypropylene glycol (meth)acrylate, ethoxy polypropylene glycol (meth)acrylate, phenoxy polyethylene glycol (meth)acrylate, nonylphenoxy polyethylene glycol (meth)acrylate, and phenoxy polypropylene glycol (meth)acrylate.

Examples of polyfunctional (meth)acrylic monomers include ethylene glycol di(meth)acrylate, diethylene glycol di(meth)acrylate, triethylene glycol di(meth)acrylate, tetraethylene glycol di(meth)acrylate, polyethylene glycol di(meth)acrylate, propylene glycol di(meth)acrylate, dipropylene glycol di(meth)acrylate, tripropylene glycol di(meth)acrylate, tetrapropylene glycol di(meth)acrylate, polypropylene glycol di(meth)acrylate, ethoxylated polypropylene glycol di(meth)acrylate, and neopentyl glycol di(meth)acrylate.

Examples of thermosetting compounds include oxetane resins, unsaturated polyester resins, alkyd resins, phenolic resins (such as novolac resins and resol resins), and melamine resins.

Examples of alkylene glycol groups include ethylene glycol groups, propylene glycol groups, and butylene glycol groups. Alkylene glycol groups may be ethylene glycol groups from the viewpoint of improving luminous efficiency and dispersibility of UC particles.

The number of repeating units (the number of m in (CₙH₂ₙO)ₘ) of an alkylene glycol group may be 1 or more or 2 or more, and may be 10 or less, 8 or less, 6 or less, 5 or less, or 4 or less from the viewpoint of more easily improving luminous efficiency.

A curable component may contain a plurality of components having different numbers of functional groups from the viewpoint of adjusting the strength, properties, and the like of a molded body. That is, a curable component may contain a first curable component and a second curable component having a greater number of functional groups than the first curable component. At least one of the first curable component and the second curable component may be a compound having an alkylene glycol group, or both of them may be a compound having an alkylene glycol group. For example, a curable component may contain a compound having an alkylene glycol group with one functional group and a compound having an alkylene glycol group with two or more functional groups, or may contain a monofunctional (meth)acrylic monomer and a polyfunctional (meth)acrylic monomer.

The ratio of the content of a first curable component on a mass basis to the content of a second curable component on a mass basis (the content of a second curable component on a mass basis/the content of a first curable component on a mass basis) may be 0.1 or more, 0.5 or more, or 1 or more, and may be 10 or less, 2 or less, or 1 or less.

Curable components may include curable components other than the compound having an alkylene glycol group (that is, curable components having no alkylene glycol group; hereinafter also referred to as “other curable components”). Examples of other curable components include UV-curable compounds and thermosetting compounds that do not correspond to the compound having an alkylene glycol group.

The content of the compound having an alkylene glycol group in a curable component based on the total amount of the curable component may be 50 mass % or more, 60 mass % or more, 70 mass % or more, 80 mass % or more, 90 mass % or more, 95 mass % or more, or 100 mass % (a mode consisting substantially of the compound having an alkylene glycol group).

The content of a curable component based on the total amount of the composition may be 80 mass % or more, 85 mass % or more, 90 mass % or more, 92 mass % or more, 94 mass % or more, or 95 mass % or more. The content of a curable component based on the total amount of the composition may be 99.9 mass % or less, 99.5 mass % or less, 99 mass % or less, 98.5 mass % or less, or 98 mass % or less.

### Other Components

The composition may further contain components other than UC particles or a curable component. The other components may include an initiator, a solvent, a coupling agent, a curing promoter (curing catalyst), a dispersant, and the like.

### Initiator

The composition according to the present embodiment may contain an initiator. The initiator may be a photoradical polymerization initiator or a thermal radical polymerization initiator, and the type of initiator can be selected depending on the method of curing the composition.

Examples of photoradical polymerization initiators include: benzoin ketals such as 2,2-dimethoxy-2-phenylacetophenone; α-hydroxy ketones such as 1-hydroxycyclohexyl phenyl ketone, 2-hydroxy-2-methyl-1-phenylpropane-1-one, and 1-[4-(2-hydroxyethoxy)phenyl]-2-hydroxy-2-methyl-1-propane-1-one; and phosphine oxides such as bis(2,4,6-trimethylbenzoyl)phenylphosphine oxide, bis(2,6-dimethoxybenzoyl)-2,4,4-trimethylpentylphosphine oxide, and 2,4,6-trimethylbenzoyldiphenylphosphine oxide.

Examples of thermal radical polymerization initiators include diacyl peroxides such as octanoyl peroxide, lauroyl peroxide, stearyl peroxide, and benzoyl peroxide; peroxy esters such as t-butyl peroxypivalate, t-hexyl peroxypivalate, 1,1,3,3-tetramethylbutyl peroxy-2-ethylhexanoate, 2,5-dimethyl-2,5-bis(2-ethylhexanoyl peroxy)hexane, t-hexyl peroxy-2-ethylhexanoate, t-butyl peroxy-2-ethylhexanoate, t-butyl peroxyisobutyrate, t-hexyl peroxy isopropyl monocarbonate, t-butyl peroxy-3,5,5-trimethyl hexanoate, t-butyl peroxylaurylate, t-butyl peroxy isopropyl monocarbonate, t-butyl peroxy-2-ethylhexyl monocarbonate, t-butyl peroxybenzoate, t-hexyl peroxybenzoate, 2,5-dimethyl-2,5-bis(benzoyl peroxy)hexane, and t-butyl peroxyacetate; and azo compounds such as 2,2′-azobisisobutyronitrile, 2,2′-azobis(2,4-dimethylvaleronitrile), and 2,2′-azobis(4-methoxy-2′-dimethylvaleronitrile).

The content of an initiator based on the total amount of a curable component may be 0.01 mass % or more, 0.05 mass % or more, or 0.1 mass % or more, and may be 5 mass % or less, 1 mass % or less, or 0.5 mass % or less.

The viscosity of the composition at 25° C. may be 0.1 mPa·s or more, 0.3 mPa·s or more, or 0.5 mPa·s or more, and may be 200 mPa·s or less, 150 mPa·s or less, or 100 mPa·s or less from the viewpoint of improving dispersibility of UC particles in the composition. The viscosity in the present specification means a viscosity measured using a rotary type viscometer under the condition of a shear rate of 10 (1/sec).

### Resin Molded Body

A resin molded body according to one embodiment of the present invention is a cured product of the above-described composition. The luminous efficiency of the resin molded body according to the present embodiment can be improved as compared to the related art.

The content of UC particles based on the total amount of the resin molded body may be 0.1 mass % or more, 0.5 mass % or more, 1 mass % or more, 1.5 mass % or more, 2 mass % or more, or 2.5 mass % or more from the viewpoint of more easily improving luminous efficiency. The content of UC particles based on the total amount of the resin molded body may be, 20 mass % or less, 10 mass % or less, 8 mass % or less, 5 mass % or less, 4 mass % or less, 3.5 mass % or less, or 3 mass % or less.

The content of a curable component based on the total amount of the resin molded body may be 80 mass % or more, 85 mass % or more, 90 mass % or more, 92 mass % or more, 94 mass % or more, or 95 mass % or more. The content of a curable component based on the total amount of the resin molded body may be 99.9 mass % or less, 99.5 mass % or less, 99 mass % or less, 98.5 mass % or less, or 98 mass % or less.

The thickness of the resin molded body may be, for example, 500 nm or more, 1 μm or more, or 2 μm or more, and may be 10 μm or less, 100 μm or less, or 1 mm or less.

### Method for Producing Resin Molded Body

The resin molded body can be produced through a production method including: a step of preparing a composition containing a curable component and particles (UC particles) containing an upconversion material that receives excitation light in a first wavelength range and emits light in a second wavelength range shorter than the first wavelength range (preparation step); and a step of curing the composition (curing step). In the method, the upconversion material contains a rare earth element, and the curable component contains a compound having an alkylene glycol group.

In the preparation step, for example, a composition may be prepared by mixing UC particles, a curable component, and other components as necessary. The order in which these components are mixed is not particularly limited, and for example, other components may be added to and dissolved in a curable component and, and then UC particles may be added thereto and mixed therewith. Mixing of these components can be performed through a well-known method. In the preparation step, for example, a composition containing at least UC particles and a curable component may be obtained from a third party.

The production method according to the present embodiment may further include a step of molding the composition (molding step) between the preparation step and the curing step. In the molding step, the composition is adjusted to a specific shape. For example, the composition may be poured into a mold or the like and molded into a specific shape, or the composition may be applied on a substrate and molded into a film.

In the curing step, the composition is cured. The method for curing the composition is selected depending on the type of curable component. For example, in a case where a curable component includes a UV-curable compound, the composition may be cured by irradiating the composition with ultraviolet light. For example, in a case where a curable component includes a thermosetting compound, the composition may be cured by heating the composition. In the curing step, pressurization may be performed during curing the composition.

The method for producing a resin molded body may further include: a processing step of processing the resulting cured product into a desired shape after the curing step. The processing step may be, for example, a step of polishing the surface of a cured product to adjust the thickness of a resin molded body.

### EXAMPLES

Hereinafter, the present invention will be described more specifically based on the examples. However, the present invention is not limited to the following examples.

### Materials Used

### UC Particles

UC particles A: NaYF₄:Yb,Er (hexagonal crystal system), average value of maximum length: 500 nm, average particle diameter: 445 nm, particles coated with oleic acid
UC particles B: NaYF₄:Yb,Er (hexagonal crystal system), average value of maximum length: 100 nm, average particle diameter: 124 nm, particles coated with oleic acid

### Curable Component

2-Ethylhexyl glycol acrylate
Tetraethylene glycol diacrylate
1,6-Hexanediol diacrylate

### Other Components

Initiator: 2,2-Dimethoxy-2-phenylacetophenone, Irgacure 651 manufactured BASF
Surfactant: Polyethylene glycol monooleate, catalog number 460176, manufactured by Sigma-Aldrich Co. LLC.

### Example 1

After mixing 2-ethylhexyl glycol acrylate with tetraethylene glycol diacrylate at a mass ratio of 1:1, an initiator was dissolved in the solution to a concentration of 0.3 mass % based on the total amount of the solution. Subsequently, 3 mass % of UC particles A based on the total amount of the solution was added thereto and stirred with a magnetic stirrer to obtain a composition.

The resulting composition was poured into a glass substrate with a spacer in between and cured by irradiating it with ultraviolet light at 365 nm for 10 minutes using a UV lamp (manufactured by AS ONE Corporation) in a nitrogen atmosphere to obtain a resin molded body.

### Example 2

A resin molded body was obtained in the same manner as in Example 1 except that UC particles B were used instead of the UC particles A.

### Comparative Example 1

After mixing 1,6-hexanediol diacrylate with a surfactant at a mass ratio of 97:3, an initiator was dissolved in the solution to a concentration of 0.3 mass % based on the total amount of the solution. Subsequently, 3 mass % of UC particles A based on the total amount of the solution was added thereto and stirred with a magnetic stirrer to obtain a composition.

The resulting composition was poured into a glass substrate with a spacer in between and cured by irradiating it with ultraviolet light at 365 nm for 10 minutes using a UV lamp in a nitrogen atmosphere to obtain a resin molded body.

### Comparative Example 2

A resin molded body was obtained in the same manner as in Comparative Example 1 except that UC particles B were used instead of the UC particles A.

### Measurement of Luminescence Quantum Yield

Measurement results of the luminescence quantum yield of the resin molded bodies obtained in Examples 1 and 2 using an absolute quantum yield measurement system (manufactured by Hamamatsu Photonics K.K., Quantaurus-QY Plus) are shown in Table 1. The measurement was performed at an excitation wavelength of 980 nm.

TABLE 1

| | | Comparative | | Comparative |
|---|---|---|---|---|
| | Example 1 | Example 1 | Example 2 | Example 2 |
| UC particles | A | | B | |
| Luminescence | 0.78 | 0.69 | 0.97 | 0.83 |
| quantum yield | | | | |

A comparison between Example 1 and Comparative Example 1 and a comparison between Example 2 and Comparative Example 2 show that even in a case of using the same UC particles, in the examples containing a compound having an alkylene glycol group as a curable component, resin molded bodies having a higher luminescence quantum yield and more improved luminous efficiency than those in the comparative examples were obtained.

What is claimed is:

1. A composition comprising:
particles comprising an upconversion material that receives excitation light in a first wavelength range and emits light in a second wavelength range shorter than the first wavelength range; and
a curable component,
wherein the upconversion material comprises a rare earth element, and
wherein the curable component comprises a compound having an alkylene glycol group.

2. The composition according to claim 1,
wherein the upconversion material comprises at least one selected from the group consisting of yttrium, ytterbium, and erbium.

3. The composition according to claim 1,
wherein the upconversion material comprises a fluoride of the rare earth elements.

4. The composition according to claim 1,
wherein an average value of maximum lengths of the particles is 100 nm to 10 μm.

5. The composition according to claim 1,
wherein an average particle diameter of the particles is 100 nm to 10 μm.

6. The composition according to claim 1,
wherein the particles are coated with an unsaturated fatty acid.

7. The composition according to claim 1,
wherein a content of the particles is 0.1 mass % to 20 mass % based on a total amount of the composition.

8. The composition according to claim 1,
wherein the compound having the alkylene glycol group is an ultraviolet curable compound.

9. The composition according to claim 1,
wherein the alkylene glycol group is an ethylene glycol group.

10. The composition according to claim 1,
wherein the curable component comprises a first curable component and a second curable component having a greater number of functional groups than the first curable component.

11. A resin molded body comprising:
a cured product of the composition according to claim 1.

12. A method for producing a resin molded body, comprising:
a step of preparing a composition comprising particles comprising an upconversion material that receives excitation light in a first wavelength range and emits light in a second wavelength range shorter than the first wavelength range, and a curable component; and
a step of curing the composition,
wherein the upconversion material comprises a rare earth element, and
wherein the curable component comprises a compound having an alkylene glycol group.

13. The method according to claim 12, further comprising:
a step of molding the composition between the step of preparing the composition and the step of curing the composition.

14. The composition according to claim 12,
wherein the compound having the alkylene glycol group is an ultraviolet curable compound, and
wherein, in the curing step, the composition is cured by irradiating the composition with ultraviolet light.
